(19) United States
(12) Patent Application Publication
(10) Pub. No.: US 2012/0107118 A1
(43) Pub. Date: May 3, 2012

(54) Wind Turbine Device Having Rotor for Starting Up and Avoiding Overspeed

(75) Inventors: Hung-Yun Wu, Taoyuan County (TW); Tai-Wei Chen, Changhua County (TW)

(73) Assignee: ATOMIC ENERGY COUNCIL-INSTITUTE OF NUCLEAR ENERGY RESEARCH, Taoyuan County (TW)

(21) Appl. No.: 12/914,487

(22) Filed: Oct. 28, 2010

(51) Int. Cl. F03D 7/06

(52) U.S. Cl. 416/41

(57) ABSTRACT

A novel vertical-axis wind turbine (VAWT) is provided. The VAWT has rotor to help starting up and avoiding overspeed. Blades of the VAWT are used for an auxiliary mechanism. By adjusting rigidity of multiple springs with torque of support blades, the blades forms equilibrium of rotating status under different wind speeds. The present disclosure makes the VAWT device more effective for improving efficiency as well as reducing cost while increase in spatiality of the VAWT is avoided.

### TECHNICAL FIELD OF THE DISCLOSURE

The present disclosure relates to a wind turbine; more particularly, relates to using blades of a vertical-axis wind turbine (VAWT) for an auxiliary mechanism, where torque of support blades is coordinated with rigidity of multiple springs to obtain equilibrium of rotating statuses under various wind speeds.

### DESCRIPTION OF THE RELATED ARTS

Vertical-axis wind turbine (VAWT) is named by its vertical shaft and blades perpendicularly positioned on it. The VAWT uses a blade set to rotate the vertical shaft perpendicularly stand on the ground. The VAWT can use winds from all directions so that, when wind direction changes, the VAWT does not have to change its direction.

Technology of the VAWT uses drag for obtaining wind energy. However, at any moment, only a half of the blades are functioned. Traditionally, the VAWT has fixed parts to obtain biggest drag for downwind and smallest drag for upwind. Hence, owing to its fixed parts, if a small wind can start up the VAWT, the VAWT has to shut down for a big wind; on the contrary, if a big wind is required to start up the VAWT, wind energy can not be effectively obtained and its working hours are short. As a result, the VWAT is not widely used in the market. Although some VAWTs introduce blades having big specific surface for reducing wind velocity requirement, the volume of the VWAT becomes huge.

In general, the VAWT is not started up by a small wind easily. It is usually abided by a power source for starting up, like an induction generator. However, an induction generator has lower power efficiency than that of a permanent-magnet generator, not to mention that it is stand-alone, not grid tie, and so does not provide power to the VAWT easily. Besides, if the VAWT is easily started up by a small wind, its efficiency will be not good for a big wind, vice versa. Furthermore, for preventing the VAWT from burning owing to overspeed under a sudden or very big wind, an extra over-speed protector is usually equipped for a small-middle VAWT and so usage of the VAWT is limited by the cost and spatiality it requires.

Hence, the prior arts do not fulfill all users' requests on actual use.

### SUMMARY OF THE DISCLOSURE

The main purpose of the present disclosure is to use blades of a VAWT for an auxiliary mechanism, where torque of support blades is coordinated with rigidity of multiple springs to obtain equilibrium of rotating statuses under various wind speeds.

The second purpose of the present disclosure is to start up the VAWT at a low wind speed from a stopped status and automatically reduce rotating velocity from overspeeding at a high wind speed by braking pneumatically, where wind energy is effectively used for improving system efficiency and, furthermore, spatiality of the VAWT is saved for reducing cost

To achieve the above purposes, the present disclosure is a wind turbine device having a rotor for starting up and avoiding overspeed, comprising a vertical shaft positioned on an assembling seat to rotate; two blade assemblies separately positioned at upside and downside of the vertical shaft; and a blade set comprising a plurality of blades, where each of the blade assemblies has a horizontal rod extended from a rim of each of the blade assemblies to rotate around the vertical shaft; where each of the blades is conjoined with one of the blade assemblies through the horizontal rod to rotate the vertical shaft by rotating itself; where the plurality of blades comprises a plurality of vertical blades and a plurality of support blades; where, through a bearing and a spring, each of the support blades is connected with upside and downside of one of the vertical blades and with the blade assemblies at upside and downside of each of the support blades; and where rigidity of the spring is coordinated with torque of the support blade to obtain a rotation mechanism. Accordingly, a novel wind turbine device having a rotor for starting up and avoiding overspeed is obtained.

### BRIEF DESCRIPTION OF THE DRAWINGS

The present disclosure will be better understood from the following detailed description of the preferred embodiment according to the present disclosure, taken in conjunction with the accompanying drawings, in which

FIG. 1 is the explosive view showing the preferred embodiment according to the present disclosure;

FIG. 2 is the view showing the starting-up process; and

FIG. 3 is the view showing the stopping process on overspeeding.

### DESCRIPTION OF THE PREFERRED EMBODIMENT

The following description of the preferred embodiment is provided to understand the features and the structures of the present disclosure.

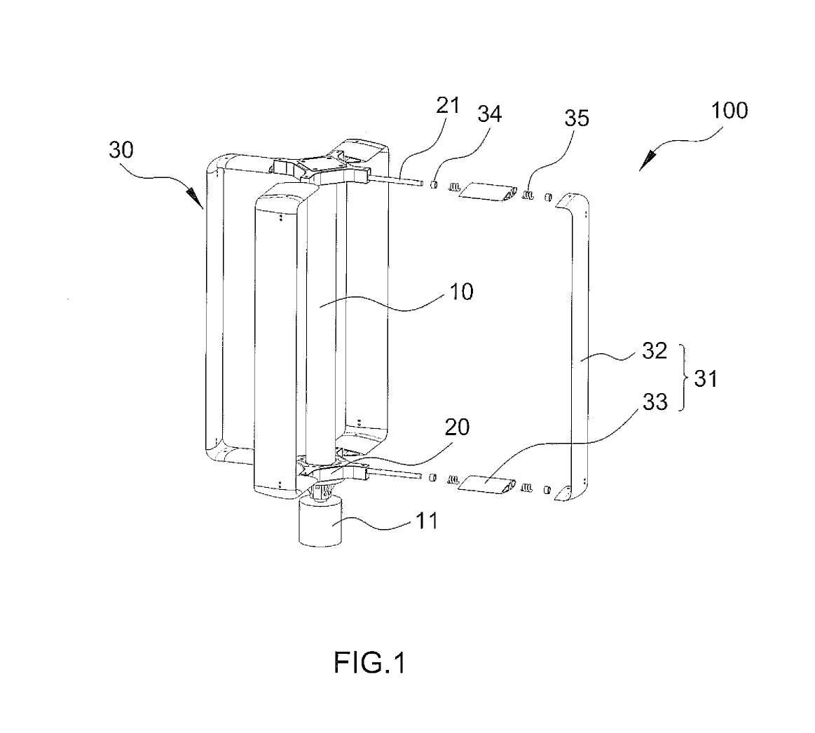

FIG. 1 is an explosive view showing a preferred embodiment according to the present disclosure. As shown in the figure, the present disclosure is a wind turbine device having a rotor for starting up and avoiding overspeed, comprising a vertical shaft 10, two blade assemblies 20 and a blade set 30, where blades of a vertical-axis wind turbine (VAWT) 100 are used for auxiliary mechanism.

The vertical shaft 10 is a shaft vertically positioned, whose lower end is assembled on an assembling seat 11 for rotating the VAWT 100 by rotating itself.

The blade assemblies 20 are separately installed at upside and downside of the vertical shaft 10, where a horizontal rod 21 is set on rim extended from each of the blade assemblies 20 for rotating around the vertical shaft 10.

The blade set 30 comprises a plurality of blades 31. Each of the blades is conjoined with a blade assembly 20 through the horizontal rod 21 to rotate the vertical shaft 10 by rotating itself. Therein, the plurality of blades 31 comprises a plurality of vertical blades and a plurality of support blades 33; each of the support blades 33 is conjoined with upside and downside of one of the vertical blades 32 at two sides of each of the support blades 33 and with the blade assemblies 20 at upside and downside of each of the support blades 33 through a bearing 34 and a spring 35; and, thus, rigidity of the spring 35 is coordinated with torque of the support blade 33 to rotate the blades 31 under a certain condition.

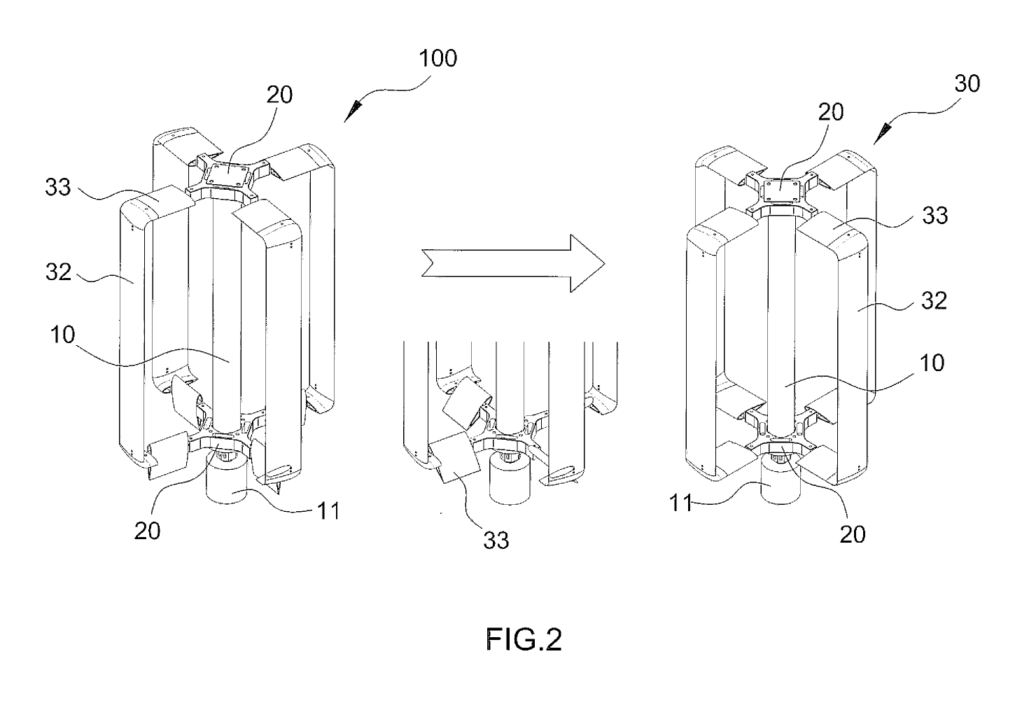

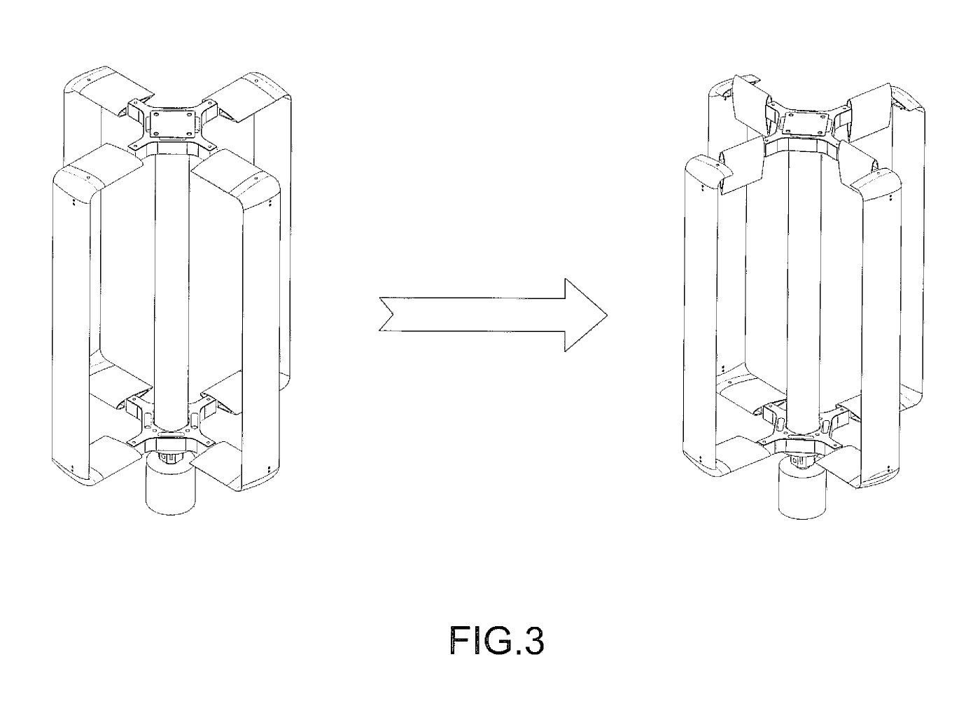

FIG. 2 and FIG. 3 are views showing a starting-up process and a stopping process on overspeeding. As shown in the figures, on using the present disclosure, a spring 35 comprising multiple springs is used in various rotating status.

In FIG. 2, when the VAWT 100 is in a stopped status, at least one support blade 33 at lower side is positioned vertically to help starting up with drag and is then returned to be positioned horizontally on reaching a predestined rotating velocity without affecting efficiency of the VAWT 100.

In FIG. 3, when the VAWT 100 is rotated under a rated rotor speed, if a sudden wind comes or wind speed increases a lot to make a rotating velocity of the VAWT 100 become very high, i.e. overspeed, at least one support blade 33 at upper side is turned to be positioned vertically to immediately reduce the rotating velocity with drag.

Thus, the present disclosure uses torque of a support blade and rigidity of springs to obtain equilibrium of rotating statuses under various wind speeds for starting up at a low wind speed from a stopped status and for automatically reducing rotating velocity from overspeeding at a high wind speed by braking pneumatically. Thus, wind energy is effectively used for improving system efficiency; and, furthermore, spatiality of a VAWT is saved for reducing cost.

To sum up, the present disclosure, is a wind turbine device having a rotor for starting up and avoiding overspeed, where blades of a VAWT are used for an auxiliary mechanism; torque of support blades is coordinated with rigidity of multiple springs to obtain equilibrium of rotating statuses under various wind speeds; and, thus, wind energy is effectively used for improving system efficiency and spatiality of a VAWT is saved for reducing cost.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A wind turbine device having a rotor for starting up and avoiding overspeed, comprising:
a vertical shaft, said vertical shaft being positioned on an assembling seat to rotate;
two blade assemblies, said blade assemblies being separately positioned at an upside and a downside of said vertical shaft, each of said blade assemblies having a horizontal rod extended from a rim of each of said blade assemblies to rotate around said vertical shaft; and
a blade set, said blade set comprising a plurality of blades, each of said blades being connected with a respective one of said blade assemblies through said horizontal rod to rotate said vertical shaft,
wherein said plurality of blades comprises a plurality of vertical blades and a plurality of support blades;
wherein, through a respective bearing and a respective spring, each of said support blades is connected with an upside and a downside of a respective one of said vertical blades and with said blade assemblies at an upside and a downside of each of said support blades; and
wherein rigidity of said spring is coordinated with torque of the respective support blade to obtain a rotation mechanism.

2. The wind turbine device according to claim 1, wherein said spring comprises multiple springs used in various rotating statuses.

3. The wind turbine device according to claim 1, wherein at least one support blade is vertically positioned to help starting up said wind turbine device with drag when said wind turbine device is stopped and then is returned to be horizontally positioned when said wind turbine device reaches a predestined rotation velocity.

4. The wind turbine device according to claim 1, wherein at least one support blade at said upside of said vertical blade is vertically positioned to reduce rotation velocity with drag when said wind turbine device is overspeeded under a rated rotor speed.
